(19) United States
(12) Patent Application Publication
(10) Pub. No.: US 2025/0072344 A1
(43) Pub. Date: Mar. 6, 2025

(54) WIRELESS COMMUNICATIONS MODULE AND SYSTEM FOR CONTROLLING WIRELESS AUTOMATED GATED PIPE IRRIGATION VALVES

(71) Applicants: James Lee Ries, Erie, CO (US); Daniel Wesley Hoekstra, Scottsdale, AZ (US)

(72) Inventors: James Lee Ries, Erie, CO (US); Daniel Wesley Hoekstra, Scottsdale, AZ (US)

(21) Appl. No.: 18/820,443

(22) Filed: Aug. 30, 2024

Related U.S. Application Data
(60) Provisional application No. 63/535,440, filed on Aug. 30, 2023.
(60) Provisional application No. 63/535,448, filed on Aug. 30, 2023.

(51) Int. Cl. A01G 25/16; G05D 7/06; G08C 17/02

(52) U.S. Cl. CPC A01G 25/165; G05D 7/0652; G08C 17/02

(57) ABSTRACT

An automated irrigation system includes a plurality of sections of irrigation pipe. A wireless communication module is coupled to one or more of the sections of irrigation pipe. A central processing system is in communication with the wireless communication module. A plurality of wireless automated gated pipe valve assemblies are coupled to the one or more of the sections of irrigation pipe. Each of the wireless automated gated pipe valve assemblies includes one or more gate valves. Operation of the one or more gate valves is controlled by the central processing system.

### CROSS-REFERENCE TO RELATED APPLICATIONS

This application claims benefit under 35 U.S.C. § 119 (e) of U.S. Provisional Application having Ser. No. 63/535,440, filed Aug. 30, 2023, and of U.S. Provisional Application having Ser. No. 63/535,448 filed Sep. 8, 2023, which are hereby incorporated by reference herein in its entirety.

### BACKGROUND

The embodiments herein relate generally to irrigation systems, and more particularly, to a wireless communications module and system for controlling wireless automated gated pipe irrigation valves.

Traditional gated pipe irrigation systems used for agricultural irrigation utilize numerous pipe sections extending thousands of feet across the fields. Each set of pipe sections include hundreds of manually operated gate valves. Controlling and monitoring a large number of individual automated gated pipe valves within a gated pipe irrigation system over great distances is both extremely complex and expensive.

Some systems use wireless communication to control the valves. Placing cellular and/or long-range wireless communication devices within a great number of individual self-powered gated pipe valves is extremely expensive and needlessly complex. A single wireless network is not able to easily expand to the number of nodes required to support the required number of individual powered or self-powered gated pipe valves within a gated pipe irrigation system. Cellular systems are both initially expensive to implement and require monthly/on-going subscription fees. Extremely long power and/or signal cables are both expensive and very prone to damage within agricultural settings.

Alternatively, physically connecting a great number of individual gated pipe valves, or physically connecting a plurality of control modules directly to an on-site central processing system using individual cables would be both costly and prone to damage. Alternatively, physically connecting a great number of individual gated pipe valves, or physically connecting a plurality of control modules directly to an on-site central processing system using individual cables would be both costly and prone to damage.

### SUMMARY

In one embodiment of the subject technology, an automated irrigation system is provided. The system includes a plurality of sections of irrigation pipe. A wireless communication module is coupled to one or more of the sections of irrigation pipe. A central processing system is in communication with the wireless communication module. A plurality of wireless automated gated pipe valve assemblies are coupled to the one or more of the sections of irrigation pipe. Each of the wireless automated gated pipe valve assemblies includes one or more gate valves. Operation of the one or more gate valves is controlled by the central processing system through the wireless communication module.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of an automated irrigation system, in accordance with an embodiment of the subject technology.

FIG. 2 is a partial view of a section of irrigation pipe and a central processing system for controlling valves in the pipe, in accordance with an embodiment of the subject technology.

FIG. 3 is a partial view of a section of irrigation pipe showing internal features of a wireless communications module on the pipe, in accordance with an embodiment of the subject technology.

FIG. 4 is an enlarged isolated view of the wireless communications module of FIG. 3, in accordance with an embodiment of the subject technology.

FIG. 5 is a block diagram of an automated irrigation system, in accordance with an embodiment of the subject technology.

FIG. 6 is a partial view of a section of irrigation pipe and a central processing system for controlling valves in the pipe, in accordance with an embodiment of the subject technology.

FIG. 7 is a partial view of a section of irrigation pipe showing internal features of a wireless communications module on the pipe, in accordance with an embodiment of the subject technology.

FIG. 8 is an enlarged isolated view of the wireless communications module of FIG. 3, in accordance with an embodiment of the subject technology.

FIG. 9 is a block diagram of a control system for controlling valves in irrigation systems consistent with embodiments of the subject technology.

### DETAILED DESCRIPTION OF CERTAIN EMBODIMENTS

In general, and referring to the Figures, some embodiments of the disclosed subject technology provide a wireless communications module and system that control gated valves in irrigation systems. Embodiments subdivide the overall gated pipe irrigation system to control and manage the individual self-powered gated pipe valves within each individual gated pipe section or a small grouping of pipe sections. Operation of the gate valves may be programmed into a central processing system to control the amount of irrigation flow, duration of flow, timing, and sequencing of opening gate valves.

As will be appreciated, aspects of the module and system greatly minimize the complexity and cost of controlling a large number of automated gated pipe valves within a gated pipe irrigation system. By implementing wireless communication modules within each individual gated pipe section or within a small grouping of pipe sections, long cables are eliminated from site and greatly reduces the number of long-distance communication nodes required to support the required number of individual gated pipe valve assemblies within a gated pipe irrigation system.

Other embodiments of the disclosed subject technology provide automated control of gated valves in irrigation systems. Embodiments subdivide the overall gated pipe irrigation system to control and manage the individual automated gated pipe valves within each individual gated pipe section or a small grouping of pipe sections. As will be appreciated, aspects of the module and system greatly reduce the overall number of wireless communication endpoints with either an on-site central processing system or an off-site cellular remote server. Some embodiments also reduce both power and signal cable lengths to the individual gated pipe valves.

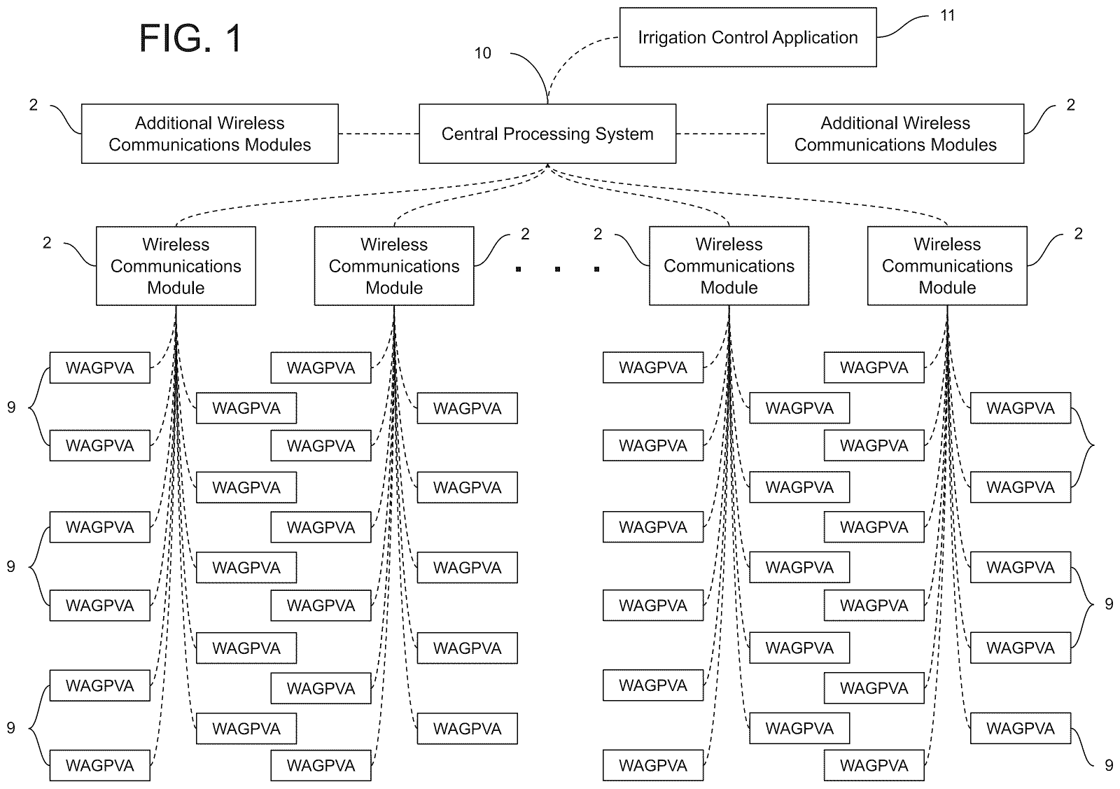

FIG. 1 shows an irrigation system using wireless control according to an embodiment. The irrigation system includes a central processing system 10 in wireless communication with a plurality of wireless communications modules 2 present on different sections of irrigation pipes. The central processing system 10 may be controlled by an irrigation control application 11. The irrigation control application 11 is a software application that may run on a remote server and communicates with the central processing system 10 via a wireless connection. The central processing system 10 may communicate with wireless communication modules 2 at least 400 meters away. The irrigation control application 11 may include one or more user interfaces that provide user input configured to control irrigation settings and operation of valves in sections of pipe within the irrigation system. In some embodiments, there may be additional wireless communications modules 2 not necessarily present on a section of pipe. The additional wireless modules 2 to auxiliary elements in the system including for example, mainline valves, flush valves, end of row water sensors, water level sensors in the pipe, etc. All the auxiliary elements may communicate to the central processing system 10 for control operations through the wireless communication modules 2.

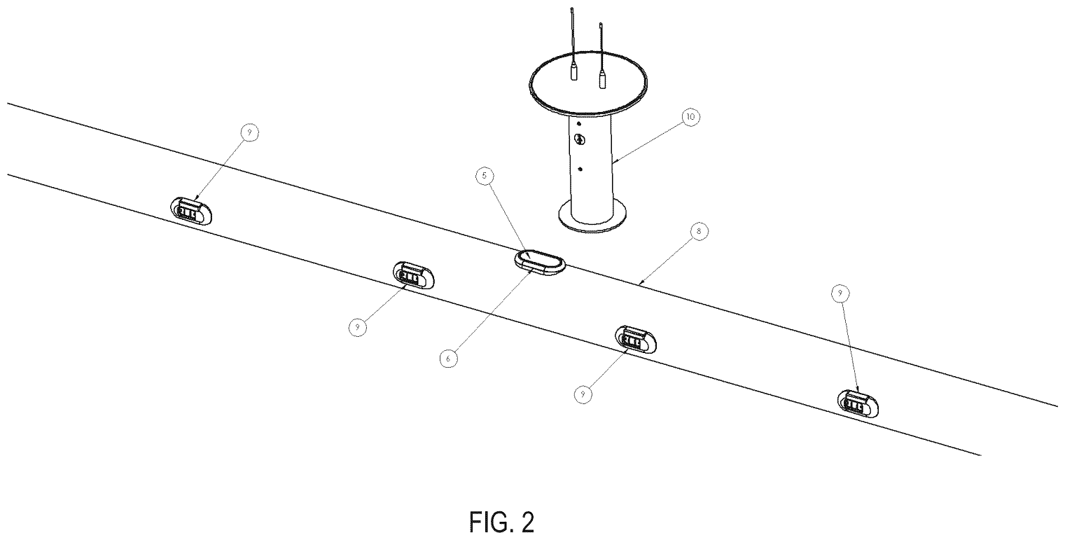

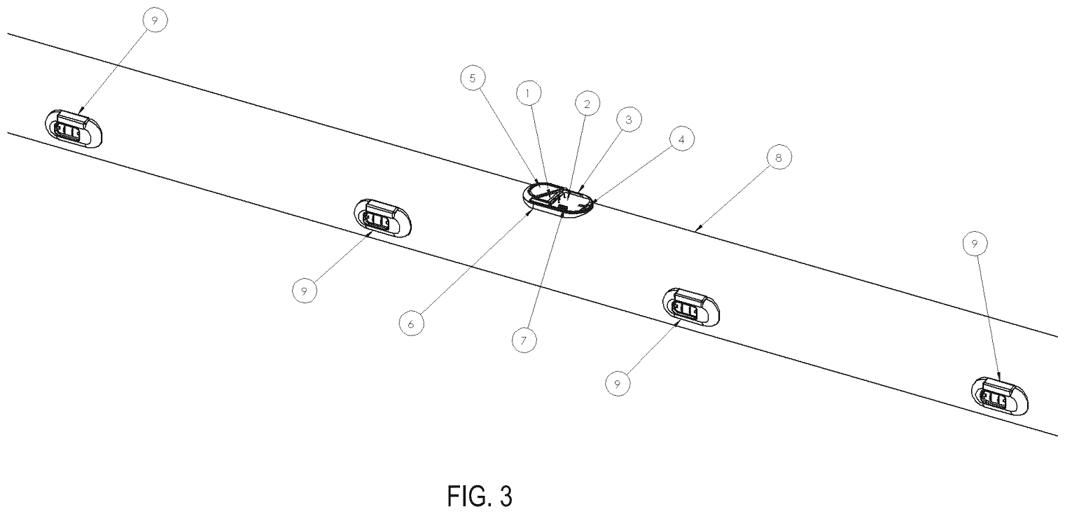

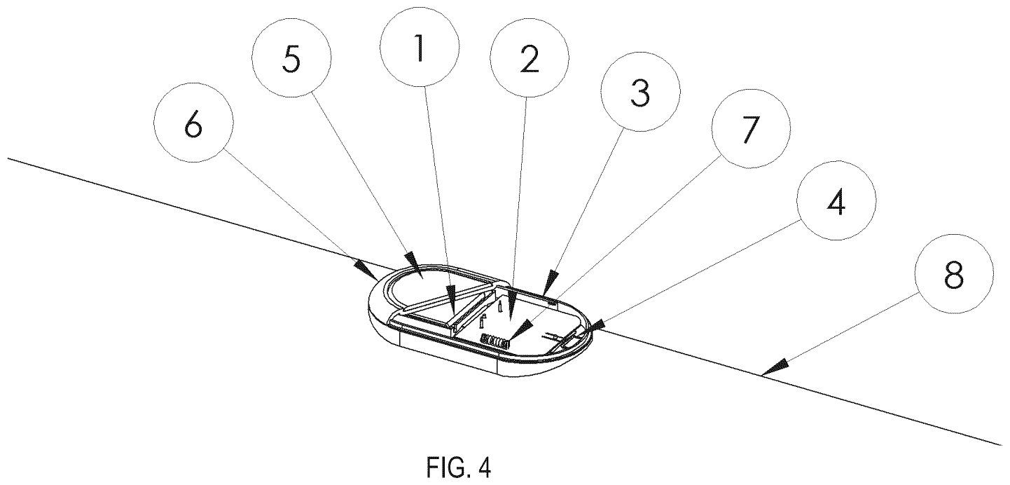

Referring now to FIGS. 2-4, details of the individual pipe sections and central processing systems 10 are shown according to an embodiment. Mounted to the external surface of the housing 6, a solar panel 5 collects solar energy which is stored in the power storage battery 1 and is used to power the wireless communications module 2. Each of the plurality of assigned wireless automated gated pipe valve assemblies 9 may be affixed to the tubular gated pipe section 8 and are powered by electronics for solar energy harvesting and power storage batteries contained within each of the wireless automated gated pipe valve assemblies 9. Each assigned wireless automated gated pipe valve assembly 9 communicates wirelessly to the wireless communications module 2 through the valve communication antenna 7 to control each valve assembly's state of operation. The long-distance communication antenna 3 is connected to the wireless communications module 2 and is used to communicate wirelessly with the central processing system 10. Operating instructions for the plurality of assigned wireless automated gated pipe valve assemblies 9 is transmitted from the central processing system 10 to the wireless communications module 2 through the long-distance communication antenna 3. Each of the wireless automated gated pipe valve assemblies 9 may be operated independently of the other wireless automated gated pipe valve assemblies 9. Each gate valve in the system may be operated independently of the other gate valves. The near field communication antenna 4 is connected to the wireless communications module 2 and is used to accept external user input to the wireless communications module 2 within the gated pipe irrigation system. The housing 6 can be affixed to the tubular gated pipe section 8 or located adjacent to the tubular gated pipe section 8.

The power storage battery 1 provides electrical power to the wireless communications module 2 for all electronic functions. The wireless communications module 2 receives electrical power from the solar panel 5 and transfers that electrical power to the power storage battery 1. The wireless communications module 2 receives operating power from the power storage battery 1 to power its own logic functions and antennas. The long-distance communication antenna 3 is attached to the wireless communications module 2 and used to communicate with the central processing system 10 to transmit and receive operational instructions and status. The near field communication antenna 4 is attached to the wireless communications module 2 and is used to facilitate external user input to the wireless communications module 2 within the overall gated pipe irrigation system. The solar panel 5 harvests solar energy and generates electrical power that is transmitted to the wireless communications module 2 for the purpose of storing this energy in the power storage battery 1. The housing 6 provides environmental protection for all internal wireless communication module components 1; 2; 3; 4; and 7 and is used as an external mounting surface for the solar panel 5. The valve communication antenna 7 provides communication from the wireless communications module 2 to each of the assigned plurality of wireless automated gated pipe valve assemblies 9. The central processing system 10 is used to manage the operational functions and communicate with all wireless communications modules 2 within the gated pipe irrigation system. The tubular gated pipe section 8 is used to transmit the flow of fluids to the agricultural irrigation region and to provide a mounting surface for the plurality of all assigned wireless automated gated pipe valve assemblies 9.

The irrigation control application 11 coordinates the overall operation of the irrigation system. The irrigation control application 11 is accessible via an Internet or other telecommunications connection and allows a user to program the desired behavior of the irrigation system. Gate control commands are sent wirelessly from the irrigation control application 11 to the central processing system 10, which in turn are forwarded to the desired wireless communications module 2 through the long-distance communication antenna 3. The wireless communications module 2 then sends the command wirelessly using the valve communication antenna 7 to the desired wireless automated gated pipe valve assembly 9 on a particular tubular gated pipe section 8.

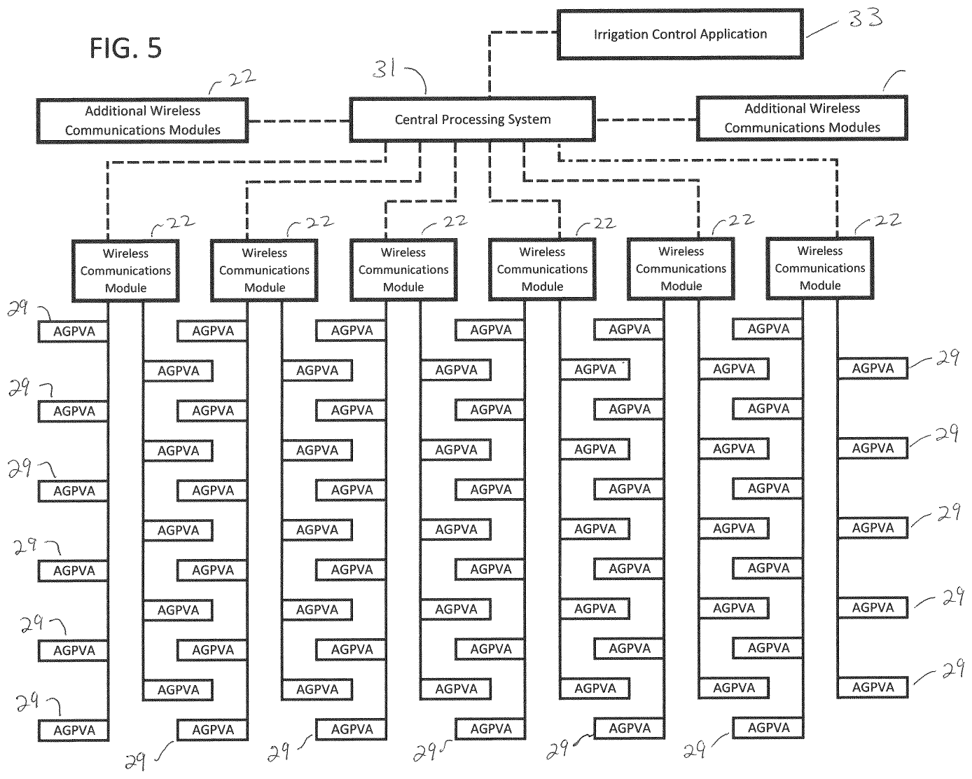

FIG. 5 shows an irrigation system according to another embodiment. The irrigation system in FIG. 5 includes a central processing system 31 connected to a plurality of wireless communications modules 22 present on different sections of irrigation pipes. Each pipe includes a plurality of assigned individual automated gated pipe valve assemblies 29 controlled by a wireless communications module 22. The central processing system 31 may be controlled by an irrigation control application 33. The irrigation control application 33 is a software application that may run on a remote server and communicates with the central processing system 31 via a wireless connection. The irrigation control application 33 includes one or more user interfaces configured to receive user input controlling the operation and setting of individual automated gated pipe valve assemblies 29. In some embodiments, there may be additional wireless communications modules 22 not necessarily present on a section of pipe.

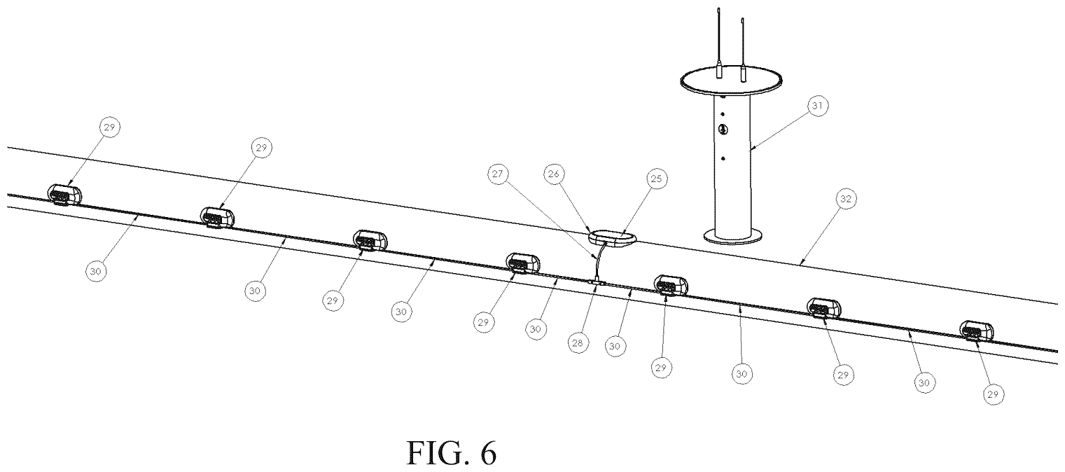

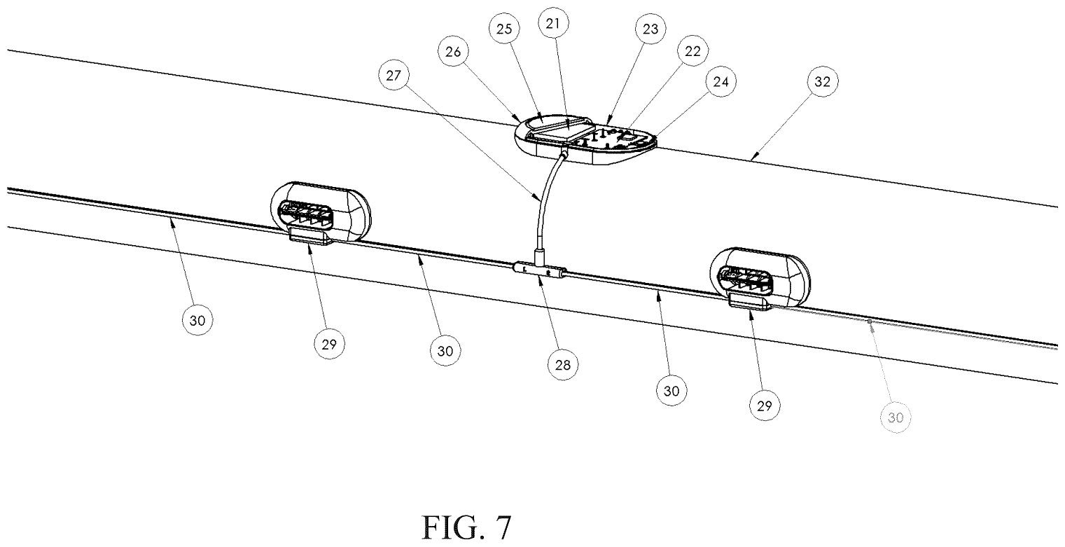

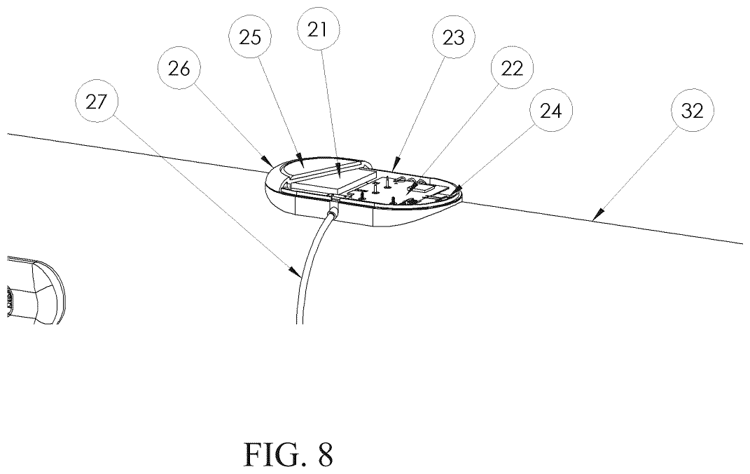

Referring now to FIGS. 6-8, details of the individual pipe sections and central processing systems 31 are shown according to an embodiment. Mounted to the external surface of the housing 26, the solar panel 25 collects solar energy which is stored in the power storage batteries 21 and used to power both the wireless communications module 22 and a plurality of assigned individual automated gated pipe valve assemblies 29. Power to the plurality of assigned individual automated gated pipe valve assemblies 29 affixed to the tubular gated pipe section 12 is transmitted via the external power cable 27 to the external power splicing assembly 28 and then to the automated gated pipe valve assembly power distribution cable 30. Each assigned automated gated pipe valve assembly 29 connects to the automated gated pipe valve assembly power distribution cable 30 to control the valve's state of operation. The long-distance communication antenna 33 is connected to the wireless communications module 22 and is used to communicate wirelessly with the central processing system 31. Operating instructions for the plurality of assigned automated gated pipe valve assemblies 29 is transmitted from the central processing system 31 to the wireless communications module 22 via the long-distance communication antenna 23. The near field communication antenna 24 is connected to the wireless communications module 22 and is used to accept external user input to the wireless communications module assembly within the gated pipe irrigation system. The wireless communications module housing 26 can be affixed to the tubular gated pipe section 32 or located adjacent to the tubular gated pipe section 32.

The power storage batteries 21 provide electrical power to the wireless communications module 22 for all electronic functions. The wireless communications module 22 receives electrical power from the solar panel 25 and transfers that electrical power to the power storage batteries 21. The wireless communications module 22 receives operating power from the power storage batteries 21 to both power a plurality of assigned automated gated pipe valve assemblies 29 as well as its own logic functions. The long-distance communication antenna 23 is attached to the wireless communications module 22 and used to communicate with the central processing system 31 to transmit and receive operational instructions and status. The near field communication antenna 24 is attached to the wireless communications module 22 and is used to facilitate external user input to the wireless communications module 22. The solar panel 25 harvests solar energy and generates electrical power that is transmitted to the wireless communications module 22 for the purpose of storing this energy in the power storage batteries 21. Housing 6 provides environmental protection for all internal wireless communication module components and is used as a mounting surface for the solar panel 25. The external power cable 27 is attached to the wireless communications module 22 and is used to transmit electrical power to the plurality of assigned automated gated pipe valve assemblies 29. The external power splicing assembly 28 is used to couple the external power cable 27 to the automated gated pipe valve assembly power distribution cable 30. The automated gated pipe valve assembly power distribution cable 30 is used to transmit electrical power to the plurality of assigned automated gated pipe valve assemblies 29 for operational purposes. The central processing system 31 is used to manage the operational functions and communicate with all wireless communications modules 22 within the gated pipe irrigation system. The tubular gated pipe section 32 is used to transmit the flow of fluids to the agricultural irrigation region and to provide a mounting surface for the plurality of all assigned automated gated pipe valve assemblies 29.

The irrigation control application 33 coordinates the overall operation of the irrigation system. The irrigation control application 33 is accessible via an internet connection and allows a user to program the desired behavior of the irrigation system. Gate control commands are sent wirelessly from the irrigation control application 33 to the central processing system 31, which in turn are forwarded to the desired wireless communications module 22 through the long-distance communication antenna 23 to open or close the automated gated pipe valve assembly 29 on a particular tubular gated pipe section 32.

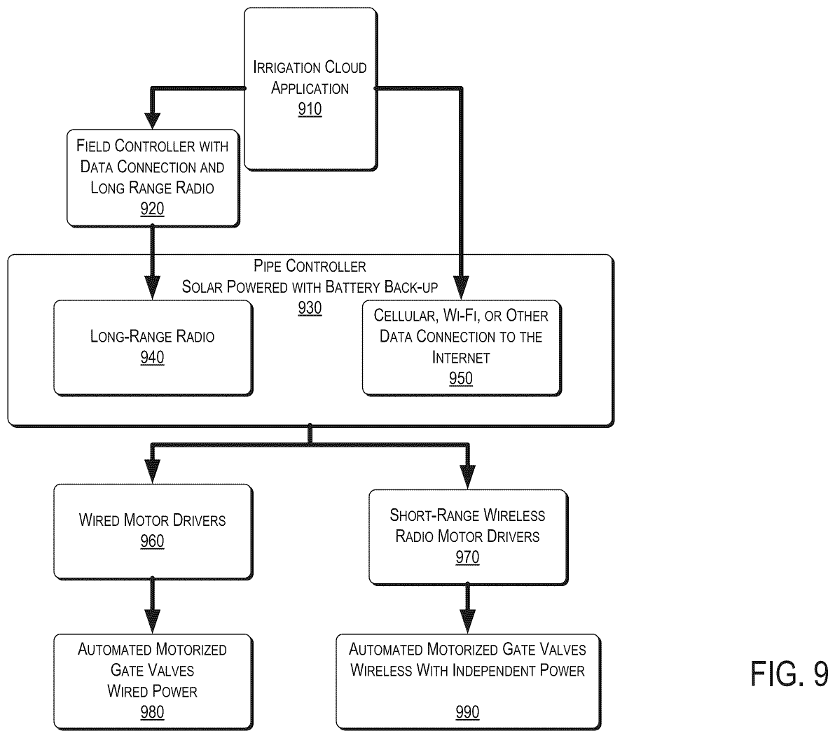

FIG. 9 shows a control system for controlling the operation of valves in irrigation systems according to an embodiment. The control system may communicate with irrigation pipes and their respect valves through a cloud-based application 910. User control data may be sent from the cloud-based application 910 to a local pipe controller module 930 that is connected to the pipe valve assemblies and other irrigation elements described above. The pipe controller module 930 may include a solar powered power source and may have a battery back-up module that may be recharged by solar power. Some embodiments may include a remote field controller module 920 that may include a data connection and a long-range radio for applications that may need long-range communication capabilities. Long-range communication may be performed via a long-range radio 940 in the pipe controller module 930. Some embodiments may include a cellular, Wi-Fi, or other data connection to the Internet module in the pipe controller module 930 for receiving user commands/settings from the cloud-based application 910. The long-range radio 940 or the cellular, Wi-Fi, or other data connection may forward communication messages for controlling the automated gate valve assemblies to either wired motor drivers 960 or to short-range wireless radio motor drivers 970. The wired motor drivers 960 control embodiments using automated motorized gate valves 980 using wired power. The short-range wireless radio motor drivers 970 control embodiments using automated motorized gate valves 990 using wireless and independent power.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An automated irrigation system, comprising:
a plurality of sections of irrigation pipe;
a wireless communication module coupled to one or more of the sections of irrigation pipe;
a central processing system in communication with the wireless communication module; and
a plurality of wireless automated gated pipe valve assemblies coupled to the one or more of the sections of irrigation pipe, wherein
each of the wireless automated gated pipe valve assemblies includes one or more gate valves, and
operation of the one or more gate valves is controlled by the central processing system through the wireless communication module.

2. The system of claim 1, further comprising an irrigation control application in communication with the central processing system and configured to communicate with the wireless communication module, wherein the irrigation control application includes one or more user interfaces configured to provide user-based commands controlling operation of the plurality of wireless automated gated pipe valve assemblies.

3. The system of claim 2, wherein the user-based commands control an amount of irrigation flow, duration of flow, timing, and sequencing of opening the one or more gate valves.

4. The system of claim 1, further comprising a solar power module coupled to the wireless communication module and configured to power the wireless communication module.

5. The system of claim 1, wherein each of the wireless automated gated pipe valve assemblies further comprise a valve communication antenna coupled to the one or more gate valves and in communication with the wireless communication module.

6. The system of claim 1, further comprising a long-distance communication antenna coupled to the wireless communication module and configured to communicate wirelessly with the central processing system.

7. The system of claim 1, further comprising near field communication antenna connected to the wireless communications module and configured to accept a user input to the wireless communications module.

8. The system of claim 1, wherein a first wireless automated gated pipe valve assembly is operated independently from a second wireless automated gated pipe valve assembly.
